(19) United States
(12) Patent Application Publication
(10) Pub. No.: US 2013/0096910 A1
(43) Pub. Date: Apr. 18, 2013

(54) METHOD AND SYSTEM FOR ADAPTING TEXT CONTENT TO THE LANGUAGE BEHAVIOR OF AN ONLINE COMMUNITY

(71) Applicants: Johann Stan, Saint-Etienne (FR); Hakim Hacid, Nozay (FR)

(72) Inventors: Johann Stan, Saint-Etienne (FR); Hakim Hacid, Nozay (FR)

(73) Assignee: ALCATEL LUCENT, Paris (FR)

(21) Appl. No.: 13/636,201

(22) PCT Filed: Apr. 14, 2011
(86) PCT No.: PCT/EP2011/055968

§ 371 Date: Nov. 27, 2012

(30) Foreign Application Priority Data
Apr. 27, 2010 (FR) 1001793

(51) Int. Cl. G06F 17/28

(52) U.S. Cl. CPC G06F 17/28
USPC 704/9

(57) ABSTRACT

A method for adapting a piece of text content to the language behavior of an online community, comprising the following steps:
establishment of a semantic tag cloud of the online community;
determining, based on the semantic tag cloud, at least one semantic vicinity of at least one concept of the text content;
reformulating the text content with the assistance of the determined semantic vicinity.

The invention relates to group electronic communication within an online community.

The word “online” here refers to the simple use of computing and electronic devices to interact with members of a community. Online communities are accessible via the Internet (Web 2.0), such as, for example, mailing lists, discussion forums, or social networks, or via an Intranet/Extranet network, such as a company's collaborative workspace, a community of practice, or the like.

Created by one or more administrators, an online community, also known as a virtual community, represents a group (collective) electronic communication place that is not real-time (asynchronous interactions) between those interested by a certain theme, which may be social, commercial, or educational in nature, for example. Any user interested by this topic may join the community and thereby interact with its members. There, they may exchange (post and/or view) text content, multimedia, or more generally speaking, data. In some online communities, only registered users identified by a password may post and/or view content.

These online communities are mainly language-based in the sense that written electronic communication is mainly the only way for a group of users to form a community.

This is because, besides the topic that interests the members, an online community is generally created by the group adopting and practicing a particular, interactional language behavior in this group electronic communication space. This causes some language practices to become ritualized over time within an online community, consequently marking a level of belonging to that community.

In other words, belonging to an online community manifests itself in sharing a vocabulary, a language register, linguistic conventions, abbreviations, acronyms, communication protocols, codes, syntactical features, and concepts collectively recognized and expected by its members, as well as by conventional linguistic norms. By way of example, in some online communities:
the capital of France is referred to as “Eiffel Tower City”; the team leader (in a collaborative workspace on an Intranet, for example) as “the Boss”, the expression “Long Term Evolution” as “LTE”, the word “good morning” as “gm”, the opposing soccer team as “the losers”, the winning team in a game, organized by the online community, by “the king”;
a message starts with “hello everyone”, and a question ends with “thanks in advance” or “thanks for your answers”;
informal T-forms (in languages such as French or Spanish) are used.

It should be noted that these language practices may have little linguistic justification per se, but they are found in the concepts, vocabulary, and especially the semantics specific to the online community. This is a linguistic culture which is only shared by the regular members of an online community. In this case, it is considered an ecosystem.

A community connection to an online community therefore involves adopting and using a language and common code specific to that community.

For a new member in a certain online community, posting a written communication (a message, an annotation, a comment, a question, or more generally an electronic text) is only successful if its wording is as expected by the regular members of that community. In an equivalent fashion, a written communication already published by that online community is only optimally understood when read if that new member recognizes (decodes) the language practice of that online community. Otherwise, any new member will feel excluded by that online community.

This is because one of the major handicaps that a user encounters when he or she joins an online community is certainly the adaptation efforts required to become a “real” member of that community. This adaptation manifests itself through quickly understanding and/or correctly wording a written text, particularly in light of the language behavior of that community.

The interpretation, by the members of an online community, of messages (particularly questions) posted by a new member—who is therefore not yet familiar with the vocabulary and semantics of that community—may take a lot of time and consequently alter the responsiveness of that community. A new user (or new member) will also need more time to understand a communication coming from that online community.

One object of the present invention is to remedy the aforementioned drawbacks.

Another object of the present invention is to propose a new value-added service to the users of an online community.

Another object of the present invention is to adapt (align) the content of a written electronic communication with the language behavior of an online community.

Another object of the present invention is to guarantee a uniform representation of the content of online communities' communication spaces.

Another object of the present invention is to encourage and improve the efficiency of information sharing within a company's network.

Another object of the present invention is to facilitate the integration of new members into an online community.

Another object of the present invention is to characterize online communities from a linguistic standpoint.

Another object of the present invention is to encourage the success of online communities.

Another object of the present invention is to encourage the emergence in a new user of a sense of belonging to a virtual community.

Another object of the present invention is to propose a socio-technical device that encourages the emergency of communications within online communities.

Another object of the present invention into improve the efficiency of group electronic communications.

Another object of the present invention is to identify online co unities' language behaviors.

To that end, the invention pertains, according to a first aspect, to a method for adapting text content to the language behavior of an online community, which method comprises the following steps:
establishment of a semantic tag cloud of the online community;
determining, based on the semantic tag cloud, at least one semantic vicinity of at least one concept of the text content;
reformulating the text content with the assistance of the determined semantic vicinity.

The invention pertains, according to a second aspect, to a device for adapting text content to the language behavior of an online community, which device comprises the following modules:
a semantic analyzer configured to establish a semantic tag cloud of the online community;
a semantic proximity calculator configured to determine, based on the semantic tag cloud, at least one semantic vicinity of at least one text content concept;
a semantic reformulator of text content using the determined semantic vicinity.

According to a third aspect, the invention pertains to a computer program product implemented on a memory medium, which may be implemented within a computer processing unit, and comprises instructions for implementing the method summarized above.

Other characteristics and advantages of the invention will become more clearly and completely apparent upon reading the description below of preferred embodiments, which is done with reference to the attached drawings in which:

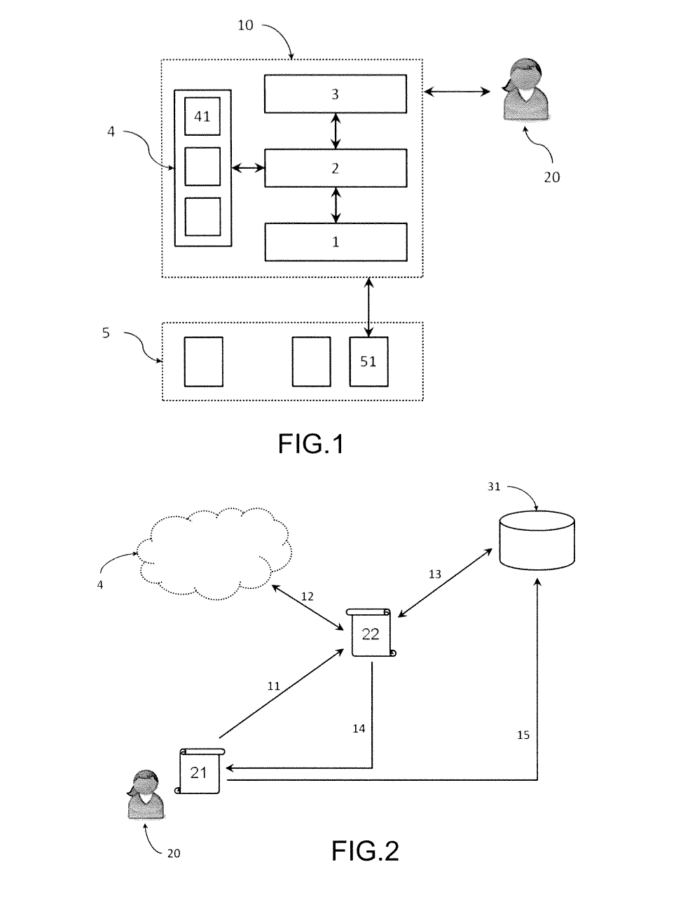

FIG. 1 schematically depicts the modules of a device for semantically adapting a piece of text content to a certain language behavior;

FIG. 2 schematically depicts a non-limiting functional architecture of a device for semantically adapting a piece of text content to a certain language behavior;

FIG. 1 depicts a user 20 proceeding to interact with an online community 51. Here, “interacting with an online community” refers to posting and/or reading electronic text content in that community's electronic communication space. By way of non-exhaustive examples, the online community 51 is
a social network such as “Facebook®”, “Twitter®”, “mySpace®”, or “hi5®”;
a personal indexing service, also known as folksonomy (social tagging), such as “Delicious®”, “Youtube®”, “Flickr®”, or “Yoolink®”;
an online discussion forum such as www.commentcamarche.net, http://forum.hardware.fr/, or http://voyageforum.com/; or
a group of users on an Intranet or Extranet network such as a collaborative workspace.

In his or her interaction with one of the online communities 5, the user 20 is assisted by a semantic adaptor 10.

The semantic adaptor 10 is configured to make a semantic projection of the text content generated by the user 20 regarding the language practices of the online community 51. This semantic projection particularly aims to best adapt the text content, which the user 20 wishes to post, to the online community's 51 language practices.

To that end, the semantic adaptor 10 is equipped with a plurality of modules including a semantic analyzer 1, a semantic proximity calculator 2, and a semantic reformulator 3.

The semantic reformulator 1 is configured to establish the semantic cloud of tags (or keywords) of an online community 51.

To do so, the semantic reformulator 1 makes a conventional analysis of the text exchanges published in the online community 51. These exchanges are generally organized as discussion threads (a single discussion subject in a forum, a single collection in “Flickr®”, a single project in a collaborative workspace, a piece of content published by a group of friends on “Facebook®”, for example).

The semantic tag cloud, established by the semantic analyzer 1, is a semantic condensation of the online community's 51 characteristic terms.

These terms are equipped with at least one metric to highlight their significance in that online community's 51 language practices.

By way of example, a metric may be the frequency of using a certain concept in interactions already posted within that online community 51. In this case, each concept is characterized by a weight reflecting its occurrence in this online community 51.

In a variant or in combination, this metric may also relate to other properties, such as, for example. Shannon distribution from information theory, which reflects the quantity of information that a concept comprises. This way, this semantic tag cloud is not just a list of the most commonly used terms in an online community 51, but rather a true semantic condensation of it. By way of example, a semantic tag cloud can simultaneously reflect the most frequent concepts of a piece of text content as well as their semantic proximities within that content (a semantic tag cloud in a tree structure, a 3D semantic tag cloud).

These concepts may concern, for example,
rules of etiquette (the introduction and conclusion of a message, salutation messages, thanks in advance);
the abbreviations;
the language register and vocabulary (business vocabulary, common/formal/familiar/popular/slang register, for example);
paralinguistic indices (smileys or emoticons);
expressive punctuation (writing in uppercase, duplicating the same symbol (multiple exclamation points, for example) to convey the intensity of an opinion or feeling);
the pragmatics of interactions (use of first names, use of informal T-forms).

Advantageously, the semantic tag cloud makes it possible to summarize an online community's 51 complex content with only the help of the language practices specific to it. In other words, the semantic analyzer 1 makes it possible to obtain a semantic image of an online community 51 based on what is commonly practiced there.

The semantic tag cloud of an online community 51 is obtained independent from any text content that a user wishes to post/read in that community.

The semantic proximity calculator 2 is operative to provide, based on a semantic tag cloud established by the semantic analyzer 1, a semantic vicinity of a piece of text content generated by the user 20, based on predefined semantic proximity reports (through synonymy, parasynonymy, or analysis of subjective logics, for example).

The semantic proximity calculator 2 is configured to determine, in the semantic tag cloud, semantic vicinities made up of the terms/concepts most representative, respectively, of the concepts identified in the text content generated by the user 20. In other words, each determined semantic vicinity preferentially comprises a plurality of concepts semantically close to an identified concept in the text content generated by the user.

Preferentially, the semantic proximity calculator 2 uses ontology metadata 4 (such as those of WordNet®, SentiWordNet®, ConceptNet®), and/or vocabulary predefined by the user 20 or generated automatically. This metadata 4 aids the semantic proximity calculator 2 in identifying the concepts included in the text content generated by the user 20, whose respective semantic vicinities are assumed to be found in the semantic tag cloud.

More generally speaking, the semantic proximity calculator 2 is a “semantic proxy” given its function of providing at least one semantic vicinity in response to a request concerning a certain piece of text content.

This semantic proxy is a piece of ontology metadata or gateway metadata leading to online communication platforms, and more particularly to social systems (social networks and social “tagging” systems like “Facebook®” or “Flickr®”).

The semantic reformulator 3 makes it possible
to retrieve from the semantic tag cloud, the terms/concepts that were semantically closest, according to the semantic proximity calculator 2, to those of the content generated by the user 20; and
to accordingly reformulate the text content generated by the user 20 with the help of the retrieved terms/concepts.

The content generated by the user 20 is therefore adapted with the help of its semantic vicinity selected from the semantic tag cloud, and then presented to the user 20.

In the event that the adapted text content is rejected by the user 20, a new adaption different from the previous one is preferentially offered to the user. To do so, the semantic reformulator 3 looks at the hierarchy of content of the semantic vicinities, determined by the semantic proximity calculator 2, with respect to the content generated by the user 20 by proceeding with a measurement of semantic proximity whose steps comprise:
evaluating the semantic distance between a concept C generated by the user 20 and the semantic cloud NS of the online community 51;
the search for another concept C′ in the vicinity of the concept C so that the semantic distance between C′ and C is minimal;
the recommendation of the concept C′ to replace the concept C, C′ being more adapted to that community's language behavior.

Different techniques for measuring semantic distance have been described, for example, in (M. Z MAALA, et al., “Distance sémantique entre concepts définis en ALE”, published in Langages et Modèles à Objets 07Toulouse, 2007). A measurement of the semantic similarity or degree of semantic relationship may also be used.

We refer now to FIG. 2, illustrating a procedure of user interaction with an online community 51.

The procedure of semantically adapting a piece of text content to the language behavior of an online community 51 enlists the aforementioned functional models in the following manner:
upon the request of the user 20 or automatically before any posting of content comprising a textual annotation 21, that annotation is communicated to the device for adapting text content to the language behavior of the online community 51 (step 11 in FIG. 2);
using the ontology metadata 4 (step 12 in FIG. 2), the semantic proximity calculator 2 identifies at least one concept in the annotation 21;
again using the ontology metadata 4 (step 12 in FIG. 2), the semantic proximity calculator 2 searches (step 13 in FIG. 2), in the semantic tag cloud 31 of the online community 51, at least one semantic vicinity of each concept identified in the textual annotation 21;
with the help of the semantic reformulator 3, the most semantically close tag cloud concepts 31, according to the semantic proximity calculator 2, are retrieved, then provided to the annotation 21, resulting in an annotation 22 adapted to the language behavior of the online community 51. The adapted annotation 22 is sent to the user 20 (step 14 in FIG. 2);
the user is free to approve or cancel, in whole or in part, the changes made to the annotation 21 (step 15 in FIG. 2).

Preferentially, the concepts modified in the original content generated by the user 20 are momentarily highlighted for the user 20, in order to facilitate the identification of changes made, thereby accelerating the appropriation of these concepts 20 by the user 30, which results in the emergence in the new user 20 of a sense of belonging to the online community 51.

It should be noted that the text content adapted to the targeted online community's language behavior is only a proposal that the user 20 can ignore or reject. In other words, the edited text content cannot be posted directly without the user's explicit approval.

Furthermore, the method described above may also be used to clarify, in light of the language behavior of an online community an identified piece of text content (selected, for example) in that community's communication space. By way of example, the use of a dictionary specific to an online community makes it possible to clarify a piece of text content published by that community, to any other user not familiar with that community (a user of a very different age than the members of that community, for example).

The method just described is particularly applicable in a business network in view of improving and facilitating communication between different work teams. Owing to this method, the members of an inter-business collaborative workspace, who have different business vocabularies/cultures, will have a better mutual understanding. This method also makes it possible to harmonize the vocabulary used (the same abbreviations, the same technical terms, for example).

The method just described exhibits a certain number of advantages. It makes it possible to align the ontology of a piece of textual electronic content with that of a targeted online community, which makes it directly intelligible by the members of that community.

This device may be implemented in the form of an extension or function associated with a Web browser and whose use may be automatic or on the user's initiative. The text content adapted by that device may be displayed, for example, in the same location as that of the original text content, in a new window/tab, or in a fact bubble, while
making it possible, preferentially, to distinguish the changes made; and
enabling the user to approve or ignore that proposal (or even disable that adaption extension/function).

1. A method for adapting text content to the language behavior of an online community, which method comprises the following steps:
establishment of a semantic tag cloud of the online community;
determining, based on the semantic tag cloud, at least one semantic vicinity of at least one concept of the text content;
reformulating the text content with the assistance of the determined semantic vicinity.

2. A method according to claim 1, wherein it further comprises a step of identifying, with the help of ontology metadata, at least one concept comprised within the text content.

3. A method according to claim 1, wherein the step of determining at least one semantic vicinity is done in accordance with predefined semantic proximity reports.

4. A method according to claim 1, wherein the determined semantic vicinity comprises a plurality of concepts semantically close to the concept identified in the text content.

5. A method according to claim 1, wherein the reformulation of the text content comprises a step of selecting a determined semantic cloud concept to replace the concept identified in the text content.

6. A method according to claim 5, wherein the selected concept is the one semantically closes to the concept identified in the text content.

7. A device for adapting text content to the language behavior of an online community, which device comprises the following modules:
a semantic analyzer (1) configured to establish a semantic tag cloud of the online community (51);
a semantic proximity calculator (2) configured to determine, based on the semantic tag cloud, at least one semantic vicinity of at least one text content concept;
a semantic reformulator (3) of text content using the determined semantic vicinity.

8. A device according to claim 7, wherein it further comprises ontology metadata (4) that makes it possible to identify at least one concept comprised within the text content.

9. A computer program product implemented on a memory medium, which may be implemented within a computer processing unit, and comprises instructions to implement a method according to claim 1.

10. A computer program product according to claim 9, wherein it is an extension associated with a Web browser.
